(19) United States
(12) Patent Application Publication
(10) Pub. No.: US 2015/0358156 A9
(43) Pub. Date: Dec. 10, 2015

(54) METHOD AND SYSTEM FOR SCRAMBLING AND DESCRAMBLING A DIGITAL IMAGE

(71) Applicant: Nagravision S.A., Cheseaux-sur-Lausanne (CH)

(72) Inventors: Pierre Sarda, Echallens (CH); Minh-Son Tran, Bourg La Reine (FR); Thierry Dagaeff, L'Isle (CH)

(73) Assignee: NAGRAVISION S.A., Cheseaux-sur-Lausanne (CH)

(21) Appl. No.: 14/383,310

(22) PCT Filed: Mar. 18, 2013
(86) PCT No.: PCT/EP2013/055585

§ 371 Date: Sep. 5, 2014

Related U.S. Application Data
(60) Provisional application No. 61/612,412, filed on Mar. 19, 2012.

(30) Foreign Application Priority Data
Mar. 19, 2012 (EP) 12160072.0

(51) Int. Cl. H04L 9/08; G09C 5/00

(52) U.S. Cl. CPC H04L 9/0816; G09C 5/00; H04L 2209/24

(57) ABSTRACT

The present invention refers to a method for scrambling an original digital image into a scrambled image and for descrambling the scrambled image into a reconstructed image. The method firstly comprises a scrambling operation for substituting a plurality of original coefficients by dummy coefficients, while safeguarding the coding format, and for storing the substituted original coefficients with their respective position, as original data into at least two control objects, each control object corresponding to a specific degradation level of the original image. This method secondly comprises a descrambling operation for receiving the scrambled image and at least a part of said control objects, and for using original data derived from a selection of at least one of said control objects, performed on the basis of a user access condition, to obtain the reconstructed image by putting back the original coefficients instead of said dummy coefficients thanks to their respective position.

### TECHNICAL FIELD

The present invention relates to the field of the protection of digital images, i.e. to the field of images under electronic format, which can be processed, broadcasted or stored in an individual manner (still images/photos isolated or grouped e.g. in a slideshow) or in the form of a video stream (e.g. an audio/video stream). In this context, this invention refers to a method for scrambling an original digital image into a scrambled image and for descrambling the scrambled image into a reconstructed image, taking into account that the reconstructed image can be different from the original image, from a visual point of view only. The invention also relates to a scrambling system and a descrambling system for performing respectively the scrambling and descrambling operations. Images processed by the present invention refer to raster graphics images (or bitmap images) of any formats (e.g. GIF, JPEG, TIFF, etc. . . . ). In particular, these images are images compressed by any known process which reduces the required memory space in view of their storage while keeping the possibility to recover the original image, owing to a reverse process. The compression involves the coding of the image and may be lossy or lossless. The choice of the image compression/decompression process does not depend from the invention.

### BACKGROUND

Against malicious purposes and for many other reasons, there is a need to secure the access to electronically stored images or photos (i.e. the information conveyed in images/photos) in particular when their physical storages are exposed to hackers or any other malicious person. This happens for example when a storing electronic server is hacked and when the physical storage of images is susceptible to be disclosed or when an image is not protected against copying processes. Each of these situations can cause problems either to the initial owner of the image or to its hoster.

For instance, when pictures are posted on internet sites, blogs or social networks (e.g. Facebook, Twitter, etc. . . . ), according to the policy of the web hoster or the web space provider, the rights on this picture (i.e. copyrights attached to the picture) are generally automatically lost and transferred to the hoster, while the legitimate owner may prefer to keep a full control on its own asset.

A known technique aiming to prevent or deter unauthorized copying of digital images and thereby preserve the copyrights of these images is the digital watermarking process. Watermarking is the process of embedding information into a digital signal which may be used to verify its authenticity or the identity of its owners, similarly as paper bearing a watermark for visible identification. If the signal is copied, then information relating to the watermark is also carried in the copy. There are generally two classes of digital watermarks: the visible watermarks and the invisible watermarks. However, none of these classes is appropriate for the purpose of the present inventions given that watermarking seeks to add information (either visible or invisible) to the digital image but this process does not seek to scramble this image.

Document US2012/063595A1 discloses a method for protecting audiovisual content organized in packets having a format identical or similar to JPEG2000 code stream. The EBCOT (Embedded Block Coding Optimized Truncation) function of JPEG2000 encoder is able to provide information relating to the distortion-to-rate ratio of each packet. The method of this document refers to a dynamical encryption process of unprotected packet (i.e. unencrypted packets). At the beginning of the process, no packet is encrypted. The first step is to protect the unprotected packet with the highest distortion-to-rate ratio. The second step is to repeat the first step until a predetermined distortion for the audiovisual content is obtained. In a variant, the data in the packets are substituted by dummy data instead of being encrypted. Such a solution does not handle only the audiovisual content given that scrambled packets of the data stream also include other information such as markers or packet headers which do not relate to elements of the image to scramble. Moreover, this method does not provide any scalability of the scrambling process.

Document US2005/078820A1 discloses an apparatus for encrypting an image by means of encryption keys and an apparatus for decrypting an encrypted image with these keys. The invention refers to images each made up of a plurality of rectangular tiles by means of a tile segmentation unit. Each tile is encrypted by means of a specific key determined by a key generation unit on the basis of encoding parameters. Each tile is further segmented into several bit streams where each bit stream corresponds to a specific resolution of the image. Therefore, when a first bit stream is decoded, a low-resolution image can be reproduced. When another bit stream is decoded in turn, an image having a higher resolution can be reproduced. When all the bit streams are decoded, an image having the highest resolution can be reproduced. Moreover, each bit stream is encrypted by a specific key and each entire image is further encrypted with another key. A reference table used to record information indicating the location of a tile and the resolution level corresponding to a given key in a bit stream must be used. The reference table must be transmitted to the decryption apparatus by a secure method. However, as being fully based on encryption processes, each user must receive several decryption keys, and in particular keys corresponding to the resolution level which has been assigned to this user in order to be able to decrypt the stream. Moreover, it should be kept in mind that encryption/decryption process involves significant computing resources, in particular a significant computing power for providing an efficient processing speed. Besides, encryption does not allow preserving the same coding format as that of the original data, or at least does not allow preserving the semantics of this coding format.

Document US2009/0214033A1 discloses an image encryption apparatus for encrypting image data within an arbitrary document and an image decryption apparatus for decrypting encrypted image data. An encrypting module encrypts the image data within an encryption area of the document by means of an encryption key corresponding to the authority level assigned to this encryption area. A decryption key generator generates one or more decryption keys corresponding to authority levels. The image encryption apparatus selects an encryption key, from among the generated encryption keys, corresponding to a required authority level for the respective encryption areas, and encrypts the image data in each encryption area with the selected encryption key. Thus, if there are four authority levels, then the key generator generates four different keys which are each input in a specific image converter of the encryption apparatus. Then, an image encrypting generator generates encrypted image data on the basis of image data received from each image converter. Finally, the image encrypting generator replaces the original image in the document by the encrypted image issued by this generator. By requiring a specific key for each security levels, the encryption/decryption apparatus must be each provided with a certain number of image converters, thus limiting the scalability of the degradation levels due to hardware elements of these apparatuses. Besides, the same problems as those mentioned in reference to the previous document persist.

Document US2010/332343A1 discloses a method for displaying multimedia content including a first step of receiving, in a receiver/decoder, data representing the multimedia content as well as disturbance data associated with the content. The second step refers to processing the data representing the content according to associated disturbance data and according to disturbance rights stored locally in the receiver/decoder. Finally, the receiver/decoder displays the multimedia content with a disturbance defined by the disturbance data according to a level of disturbance depending on local disturbance rights. Such disturbance data can consist in the insertion of a grey rectangle (or the replacement of some pixels by grey pixels) in a selected zone or the insertion of a banner containing a publicity message. Disturbance data can be more or less important depending on the disturbance rights of the user. The disturbance is applied at the user side by the receiver/decoder (by means of a sub-module SMP of the receiver/decoder) in accordance with the disturbance level which depends on the disturbance rights of the user. According to this document, the multimedia content is sent within data stream packets (in an encrypted form) to the receiver and the disturbance data are sent aside to the multimedia content. Accordingly, a malicious person could transmit or share the decryption key required for decrypting the multimedia content with another receiver/decoder and by-passing the disturbance process given that the latter is not performed by the sender.

Therefore, there is a need to provide an efficient technical solution for controlling access to such digital pictures/images.

### SUMMARY OF THE INVENTION

In order to solve the above-mentioned problems, the present invention aims to suggest a new method for scrambling/descrambling digital images in view to increase their protection, for instance depending on their usage. The scrambling/descrambling operations must be performed at a very high speed. The invention allows getting variable scrambling effects by defining several scrambling levels, each providing a specific visual degradation accordingly. Moreover, the coding format of the scrambled/descrambled image (i.e. a coded or compressed image) must be preserved. Preferably, this coding format is syntactically and semantically compliant with the coding format of the original image.

These aims are reached by a method for scrambling an original digital image into a scrambled image and for descrambling the scrambled image into a reconstructed image. The original image is defined (i.e. determined) by original coefficients in accordance with a certain predefined coding format. These original coefficients can typically refer to coding elements of this image (such as DC and/or AC coefficients of a JPEG coding format) and/or parameters of this coding format (such as quantization coefficients of a quantization matrix also known as quantization table). These coefficients belong to a bitstream (more particularly to a flowing chain of bits or to a static chain of bits) through which the images and related data can be transmitted or downloaded. As, each coefficient has a precise role into the bitstream structure, they are arranged, namely positioned, according to a definite order (i.e. position) within this bitstream. In the present description, it should be noted that the term “bitstream” is used in reference to a chain of bits, regardless if this chain is a flowing chain (a stream) or a static chain of bits. Besides, the term “coefficient”, as used in the present description, refers to a number, namely to a numerical factor or to a mathematical value of a physical parameter.

According to the present invention, each of these coefficients is identified by means of its position. This position can refer for instance to the (absolute) position of the coefficient within the bitstream, regardless of the type of coefficient. In variant, this position can refer to a position defined with respect to the image (namely a position within the image, e.g. within a block of coefficients forming a sub-image of this image) particularly when these coefficients refer to DC/AC coefficients. Finally, this position can refer to a position defined with respect to a matrix (namely a position within a matrix such as a quantization table) particularly when these coefficients refer e.g. to quantization coefficients. The present method comprises a scrambling operation and a descrambling operation as below:

The scrambling operation comprises the following steps:
receiving (and storing) the original image, if this image is not yet stored within the scrambler (hence it is an optional step),
substituting a plurality of original coefficients (i.e. original values of these coefficients) by dummy coefficients (i.e. dummy values) of the same nature so as to safeguard the coding format of the original image and preferably to safeguard also the semantics of this coding format,
storing the substituted original coefficients with their respective positions (namely their positions within the bitstream, within the image or within the conversion table) as original data into at least two control objects COs, each control object corresponding to a specific degradation level of the original image.

The descrambling operation of the method comprises the steps of:
receiving the scrambled image and at least a part of the above-mentioned control objects COs,
using original data, stored in a selection of at least one of these control objects, for obtaining the reconstructed image by retrieving, from this selection of control objects, the respective original values of the substituted original coefficient and by putting back these original values (instead of the dummy coefficients) at the appropriate location (original location) by means of their respective position.

The above-mentioned selection can be performed during the scrambling operation or during the descrambling operation. In the case where the selection is performed during the scrambling operation, therefore the control objects received during the descrambling operation derive from this selection. On the other hand, if the selection is performed during the descramble operation (by an additional step), then all the control objects generated during the scrambled operation must be previously received before performing this selection.

This selection is based on a user access condition and allows getting a scalable reconstructed image, in accordance to a specific degradation level defined by the user access condition. Thus, the user access condition defines the rights of the user for descrambling the scrambled image into a reconstructed image. Depending on the user access condition, the reconstructed image can be a partially descrambled image or a fully descrambled image (i.e. identical to the original image). According to the present invention, the reconstructed image can be scalable into a plurality of different quality levels so that this image can still be more or less scrambled. Therefore, the reconstruction of this image can be advantageously made in an adaptive and progressive manner. To this end, the present invention allows defining the quality of the reconstructed image by means of the user access condition, in particular owing to information or parameters contained in the access condition of that user. Thus the descrambling operation of the present method is performed selectively, according to access criteria. In other words it can be performed on demand, according to the profile of the user wanting to handle this image in view to see it, to copy it, to send it or in view of any other purpose. Such a method is useful for advertising/teasing application to stimulate/promote the curiosity for a final consumption.

The present invention also refers to a system for scrambling an original digital image having a certain coding format into a scrambled image having the same coding format. Preferably the scrambled image does not only safeguard the syntax of the coding format but also its semantics (by providing plausible data which are part of this coding format). To this end, this system comprises a scrambler for scrambling an original image into a scrambled image by substituting a plurality of original coefficients (e.g. referring to coding elements of the image and/or to configuration parameters of said coding format within a conversion table) by replacement coefficients (i.e. dummy coefficients) of the same nature to safeguard (i.e. to preserve) the coding format of the original image. On the other hand, the scrambler is also able to generate at least two control objects. Each control object corresponds to a specific degradation level of the original image and can be assigned to a specific user access condition. Moreover, each control object comprises, as original data, the substituted original coefficients with their respective position. This position can refer to a position within the bitstream (according to a global point of view), within the original image (according to a restricted point of view limited to image data) or within the conversion table (according to another point of view restricted to configuration data, in particular to configuration data of a conversion table).

To perform image reconstruction, the present invention also refers to a system for descrambling a scrambled image having a certain coding format into a scalable reconstructed image having the same coding format. Each image is defined by a set of orderly coefficients. Preferably, these coefficients refer to coding elements within this image and/or to parameters of the coding format within a conversion table. The scrambled image is associated with at least two control objects, each control object corresponding to a different reconstruction level of this image. Each control object comprises original data formed by substituted original coefficients and their respective positions as explained above. These control objects are then used to retrieve original values of the substituted original coefficients, for instance by replacing dummy coefficients and/or compensated coefficients (that have been put instead of original coefficients) by the respective original values of each substituted coefficients.

The descrambling system comprises an input interface for receiving the scrambled image and original data extracted from an original image from which the scrambled image was generated. This system also comprises a descrambler for generating the reconstructed image by processing at least one control object, among at least two control objects (CO1, CO2) wherein said original data has been stored in a form of 2-tuples. Each 2-tuple comprises an original coefficient and its position. These control objects are used for substituting dummy data of the scrambled image by the original coefficients thanks to their respective position.

The descrambling system comprises an output interface for outputting the reconstructed image.

It can also comprise a selection unit to select at least one of the control objects according to a user access condition.

### BRIEF DESCRIPTION OF THE DRAWINGS

The present invention will be better understood thanks to the attached figures in which:

FIG. 1 schematically shows the transformation of an original image into a scrambled image according to the present invention;

FIG. 2 schematically shows the transformation of the scrambled image of FIG. 1 into a reconstructed image according to the present invention;

FIG. 3 shows, as example, four different levels of descrambling of the reconstructed image depending on user access conditions;

FIG. 4 shows the scrambling operation according to one embodiment of the method of the present invention;

FIG. 5 shows the descrambling operation that is made after the scrambling operation of FIG. 4 to get a reconstructed image;

FIG. 6 is an illustration of a first hierarchical organization of the control objects showing the importance of their impact on the degradation of the image;

FIG. 7 is an illustration of a second hierarchical organization of the control objects showing the importance of their impact on the degradation of the image;

FIG. 8 shows the contents of three control objects comprising additional original data coming from a calculation of compensated coefficients;

FIG. 9 is a schematic illustration showing a portion of an original block of coefficients and the corresponding portion of the same block including a compensated coefficient;

FIG. 10 is a schematic representation of a descrambling system according to one embodiment of the present invention.

### DETAILED DESCRIPTION

Reference will now be made in detail to the preferred embodiments of the invention, examples of which are illustrated in the accompanying drawings. While the invention will be described in conjunction with preferred embodiments, it will be understood that they are not intended to limit the invention to these embodiments. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

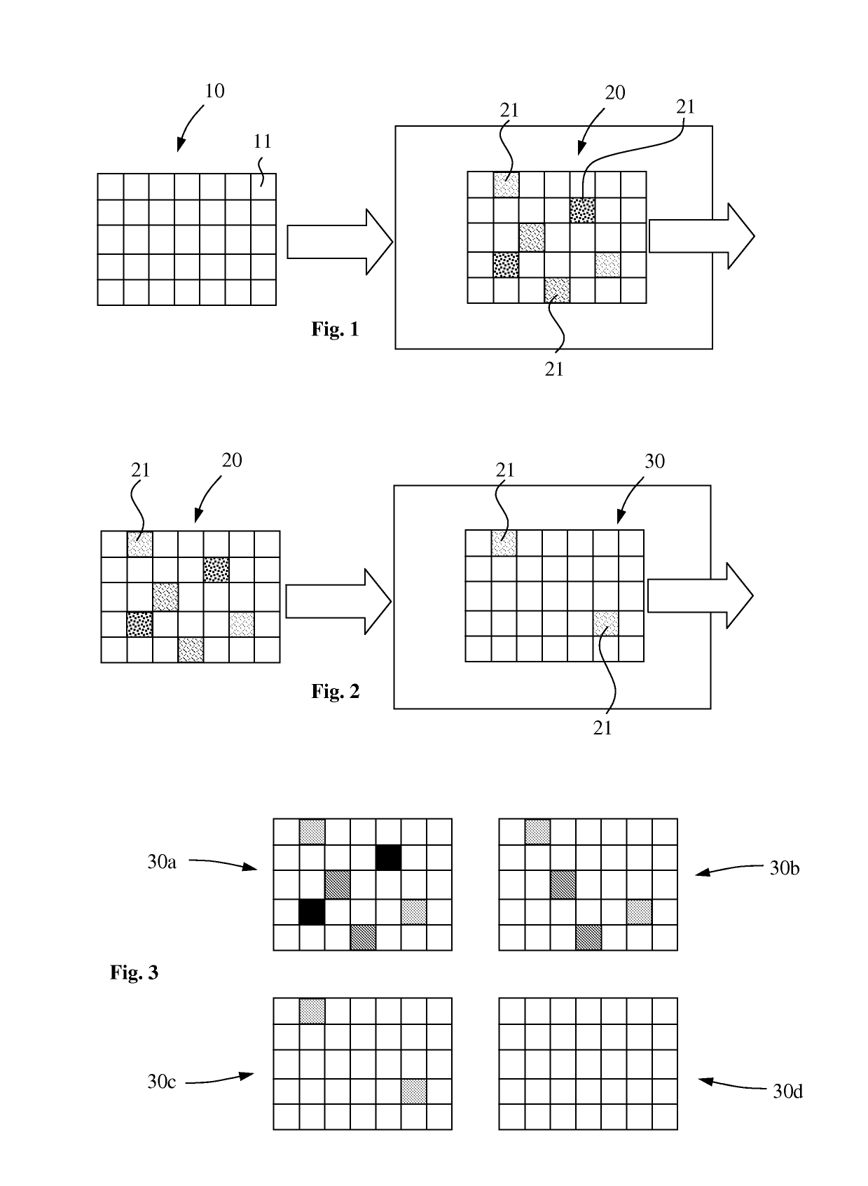

Referring to FIG. 1, it schematically illustrates the transformation of an original image 10 into a scrambled image 20. The original image 10 is a compressed image, namely a coded image having a coding format that is compliant with common players (image-rendering devices) able to process such a digital image. As schematically shown in this figure, the original image 10 results from an initial image (i.e. a raw or uncompressed image) which has been firstly divided into successive blocks 11, each corresponding to a sub-image of the initial image. Then, the divided image is stored in a memory (of the system for scrambling the original image) in order to be transformed, according to this coding format, into a set of coefficients (which can be regarded as being syntax elements). According to the preferred embodiment of the invention, these coefficients are DC coefficients and AC coefficients. Each block 11 was a matrix of 8×8 pixels which has been converted during the compression process into blocks of coefficients by means of a transformation function. Such a function can be for instance a discrete cosine transform (DCT). This kind of transformation is typically used by JPEG and MPEG standards and is therefore well known by the person skilled in the art. Each block of 64 coefficients can be then further quantized with the help of a quantization matrix comprising 8×8 coefficients (i.e. quantizers or quantization elements). Although the following description refers to blocks of DC and AC coefficients taken as preferred components, it should be understood that other coefficients or parameters, such as the elements of the quantization matrix, could be also taken into consideration instead of said DC/AC coefficients.

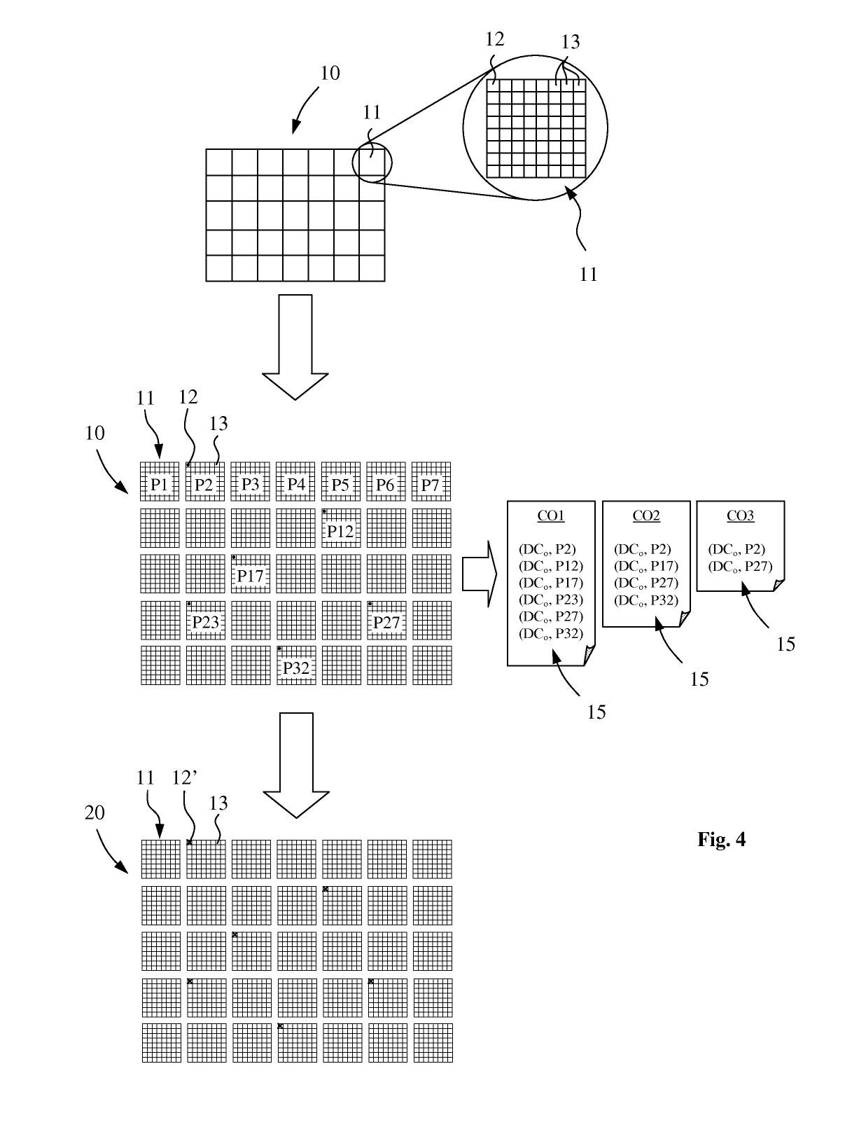

As shown in FIG. 1, the original image is transformed into a scrambled image 20. This image 20 is defined as scrambling image given that it comprises a plurality of blocks 21 which have been scrambled. According to the invention, the scrambled image 20 can be defined as being a scalable image because it contains several levels of degradation shown in this Figure by the different grey levels of the scrambled blocks 21. Further explanations will be given with reference of FIG. 4 about the scrambling operation.

FIG. 2 shows the transformation of the scrambled image 20 of FIG. 1 into a reconstructed image 30 according to the descrambling operation of the method suggested by the present invention. As shown in this figure, the reconstructed image 30 can be different from the original image 10 given that the reconstructed image can still comprise some residual scrambled block 21. Depending on an access condition assigned to a user wanting to descramble the scrambled image 20, the reconstructed image 30 can be still partially scrambled (i.e. several scrambled blocks remain intact) or can be fully reconstructed so as to be identical as the original image 10.

FIG. 3 shows, as example, four different descrambling levels of the reconstructed image, each level representing a different user access condition. These levels of degradation are schematically represented by blocks of different grey levels. By comparing the scrambled image 20 of FIG. 1 or FIG. 2, the reconstructed image 30a remains scrambled since no block 21 has been descrambled in the reconstructed image. This case may typically correspond to a denied access to get a reconstructed image for a certain user. The reconstructed image 30b corresponds to a poor access given that this image remains rather scrambled. The image 30c is rather a good reconstructed image corresponding to a better quality given that the remaining degradation level is quite low. It corresponds to a user access condition of a better level. The last reconstructed image 30d is a fully reconstructed image corresponding to the original image 10 since all the scrambled blocks 21 have disappeared. As illustrated in FIG. 3, one of the aims of the present invention is to provide a method wherein the reconstructed image can be provided with different degradation levels.

Referring to FIG. 4, the scrambling operation is now explained in more detail in the case of JPEG encoding format according to a preferred embodiment of the method of the present invention. Overall, the scrambling operation aims to substitute original data by replacement data which are denoted as being dummy data or, in other words, as being luring data, fake data, fictitious data or scrambling data. It should be noted that the present description does not distinguish between the wordings “dummy data”, “fake data”, “fictitious data” or “luring data”, since each of these wordings is considered here as referring to data used as scrambling data (namely as being data placed instead of original data). In FIG. 4, each block 11 of the original image is made of a matrix of DC and AC coefficients, in particular one DC coefficient 12 and a plurality of AC coefficients 13. The DC coefficient (Direct Coefficient) is the first coefficient of the block on the top left of the matrix, i.e. at the position (0,0) marked by a small black spot in FIG. 4. The DC coefficients 12 of all blocks 11 are encoded in a differential manner according to the JPEG standard. Therefore, the blocks 11 are dependent on each other. This dependency can affect the whole image, or groups of successive blocks separated by a special syntax element in the encoded image, namely a Restart Marker. Restart Markers act as separator, the very first DC coefficient following a Restart Marker being encoded independently, the successive DC ones being again encoded differently until the occurrence of the next Restart Marker, or the end of image.

The DC coefficient 12 is a value representing an average intensity of its block and therefore refers to an average of the quantity of the matrix of the coefficients. The AC coefficients are the remaining elements of the matrix. From the top left to the bottom right, the AC coefficients are values representing respectively the low to high frequency factors in the 2-dimensional space.

According to one embodiment of the present invention, several blocks of original image 10 (marked by references P1 . . . P7, P12, P17, P23, P27 and P32 in FIG. 4) will be scrambled.

Yet according to another embodiment, the image 10 represents a rectangular portion or zone of a complete image, and contains a plurality of blocks spread over several rows of blocks. A zone is not limited to rectangular form and can have an arbitrary shape, defined by a selection of a different number of blocks on successive rows in the image. In this case, each zone is represented by the smallest numbers of blocks that cover the entire surface delimited by the zone. A selection of several zones inside the same image is also possible.

According to a preferred embodiment of the invention, the structure of the original image 10 and the original DC coefficients 12 extracted from the aforementioned blocks are shown in FIG. 4. The original DC coefficients 12 in the targeted blocks located at positions P2, P12, P17, P23, P27 and P32 are replaced with dummy coefficients 12′ (i.e. dummy values). The value of the dummy coefficient 12′ can be generated, for example, according to a pseudo-random process. The values of original DC coefficients 12 and the locations of their blocks (i.e. positions P2, P12, . . . within the image 10) are saved in the original data 15 in a form of 2-tuple data (i.e. a pair of data). For instance, the 2-tuple data (DC₀, P2) in FIG. 4 refers to the original value of the DC coefficient of the block 11 located at position P2. All the 2-tuple data of the original data 15 are arranged into a plurality of control objects CO1, CO2, CO3, which are independently incorporated into the descrambling process later on to reconstruct the image with different level of degradation. Each time a block of coefficients is changed by at least one dummy coefficient 12′, original data 15, namely the original value of the original coefficient 12 which has been substituted by the dummy coefficient 12′, must be stored (i.e. saved) in view of a reverse process aiming to recover at least a partially descrambled image.

Advantageously, by directly storing the position (typically the absolute position) of each substituted data in a form of a 2-tuple within the control object, the present invention increases both the speed and the reliability of the process when original data have to be replaced instead of dummy data to get the reconstructed image. Indeed, thanks to the 2-tuples, the present method is very reliable because the reading of positions of the original coefficients is performed independently from any other process. Accordingly, there is no need to recognize or to interpret dummy data (i.e. dummy coefficients) to perform the descrambling process, because the storing of the positions of each substituted original coefficient allow putting back the appropriate original data at the right place, regardless data to exchange. Besides, it should be noted that increasing the speed as much as possible is crucial for real time processing, especially whenever the descrambler is located in an intermediate level, namely not necessarily coupled with the end media decoder.

The position of a data (e.g. a coefficient) can be identified in several ways. According to a first manner, this position is an absolute position defined by a unique value within a bitstream (in accordance to a positioning system assigning a position data, e.g. a position value, to each data of the bistream) which immediately enables to point the corresponding value (i.e. the coefficient corresponding to this position). This absolute position can be generated by a process (or a unit) which assigns a unique position value to each data (e.g. coefficients) within the bit stream (such as the encoded image), regardless the block 11 or the stream packet into which this data is located. According to another manner, the position of a coefficient, such as a DC coefficient or a quantization coefficient, can be defined in relation to its bloc number (e.g. P2, P12, P17, etc. . . . as shown as example above) or to its position within a matrix (such as a quantization matrix). According to yet another manner, the position of a coefficient, such an AC coefficient, can be defined both with in relation to its bloc number and its position within this bloc. For instance, the position P1709 assigned to a coefficient could refer to the 9^{th} coefficient (among the 64 coefficients of a block) of the block P17. Besides, each image 10, 20 can be further identified by a unique number which can be also included in the position data. For instance, the position referenced by the number 5540P1709 could refer to the 9^{th} coefficient of the block P17 located in the 5540^{th} image. In any case, the position as defined in the present invention enables pointing directly the appropriate coefficient.

According to the present method, one of the first steps of the scrambling operation is to receive and to store the original image 10. However, this step should be regarded as an optional step, given that the original image may be already stored in the scrambler at the beginning of the scrambling operation. This original image is structured according to a predefined coding format having a specific syntax, so as to be readable by common players (i.e. rendering means). This coding format presents also a specific semantics allowing the interpretation of an expression such as the value of a coefficient. Preferably, this coding format refers to a differential coding so that a current DC coefficient of a certain block can be determined e.g. by subtracting the value of the non-encoded previous DC coefficient to the value of non-encoded current DC coefficient.

Then, the next step refers to the substitution of a plurality of original DC and/or AC coefficients 12, 13 by dummy coefficients 12′, 13′. According to the present invention, these dummy coefficients do not define any random coefficients but coefficients of the same nature as original coefficients, in order to guarantee the syntax of the coding format of the scrambled image 20. More preferably, the dummy coefficients of the present invention ensure not only the syntax of the encoded data stream, but also the semantics of this data stream so as to keep consistent data. Accordingly, both the format and the plausibility of the coding format can be maintained. It is therefore suitable to make a distinction between the syntax and the semantics. For instance, the syntax of a coding format based onto 3-bit binary numbers is kept if each dummy data also refers to a 3-bit binary number. However, among all the 3-bit binary numbers, certain values can be regarded as being unlikely or incredible data (i.e. as being impossible data which must be put aside), because they are merely excluded from the coding format (i.e. inexistent in this coding format) and thus they do not respect the semantics of encoded data. Consequently, in order to keep also the semantics of the coding format, it is necessary to choose dummy data that may be expected in accordance to the coding format. Advantageously, by keeping the semantics of the data stream it becomes possible to fully hide each dummy coefficient among the other original coefficients of same block. Therefore, it becomes impossible for a process to identify the presence of dummy values, whereas dummy data which does not respect the semantics of the coding format can therefore be detected as being foreign data because they are unexpected data (i.e. incredible data) in the coding format in question.

As shown by the substituting step, the present scrambling process is achieved by substituting some original coefficients by such dummy data. It means that there is no intention neither to mix the blocks (or the pixels) within the image, nor to encrypt the coefficients with an encryption key since encryption/decryption process requires significant time and computing resources. Moreover, providing a scrambling effect by an encryption process does not allow safeguarding the same coding format as that of the original data, or at least does not allow safeguarding the semantics of this coding format.

In the present invention, the scrambling effect is advantageously obtained by altering certain blocks 11 (in particular by substituting original DC/AC coefficients with dummy coefficients 12′, 13′ to get fake or misleading coefficients) while retaining their position. This position can refers to a position within a bitstream (e.g. if one considers a flow of data or static data arranged in a linear manner) or it can refers to a position within the image itself (e.g. when just one still image is concerned). Advantageously, such a substituting process requires less computing time and power than an encryption/decryption process. Accordingly, time and computing resources can be saved, both from the sender and from the receiver sides (respectively, during the scrambling and descrambling processes). On the other hand, dummy coefficients are conform to the syntax of the image format (syntax of the used codec) so as to be readable by common players. More preferably, these dummy coefficients are part of plausible coefficients of the coding format in order to preserve the semantics of the encoded data. In the example provided by FIG. 4, only DC coefficients have been used in the scrambling operation for the sake of simplicity. The substituted original DC coefficients 12 are identified by positions P2, P12, P17, P23, P27 and P32.

As shown in the middle of FIG. 4 referring to one of the steps of scrambling operation, each of these substituted original DC coefficients 12 (i.e. the original values of these coefficients) is stored together with its position as original data 15 into at least two control object CO1, CO2. In the example of FIG. 4, three control objects CO1, CO2, CO3 are used for storing the original data 15 in a form of 2.tuples. Each 2-tuple is formed by the original value of the DC coefficient 12 and its position P. According to the embodiment disclosed in this figure, the first control object CO1 comprises all of the original data 15, namely the six original DC coefficients 12 (also denoted DCo) and their respective position P. The second control object CO2 only comprises a subset of original data 15 of the first control object CO1, namely the values DCo of the original DC coefficients 12 located at positions P2, P17, P27, P32. The last control object CO3 also comprises a subset of the original data 15 present in one of the previous control objects CO1, CO2, in particular original DC coefficients 12 of positions P2 and P27.

Each control objects CO1, CO2, CO3 corresponds to a degradation level of the original image 10, since the first control object CO1 comprises all the required original data 15 to recover the original image, whereas each of the other control objects CO2, CO3 only comprises a specific part of all the original data. The degradation level of the third control object CO3 is therefore higher than the degradation levels of the two other control objects CO1 and CO2.

In the embodiment shown as example in FIG. 4, original DC coefficients 12 have been replaced by dummy coefficients 12′. However, it should be noted that the present invention is not limited to the replacement of original DC coefficients, but it is also fully applicable for the replacement of original AC coefficients or even both to DC and AC coefficients, given that AC and DC coefficients are values having the same syntax, so that nothing allows to identify them except their position within the matrix.

In variant the coefficients stored in the control objects can refer to quantizers (i.e. data used for the configuration of the decoding) instead of DC and/or AC coefficients. In this case, the substitution is applied to the quantizers in the quantization table (i.e. the conversion table which is also known as quantization matrix). Because the quantization table is a global parameter of the JPEG format, modifying its quantizers affects all blocks of the compressed image during the compression step. Therefore, in this embodiment, 2-tuple data of the original data 15 no longer contain the value of the DC/AC coefficient together with the position of the affected block. Instead, they consist of the original quantizer and its index-location in the quantization table or its position within the bitstream. Thus, the 2-tuple still comprises both a value and the position of this value, but the value refers now to a quantization value (instead of coefficient value) and the position can refer now to a position within the conversion table (instead of a position within the image). For instance, a possible original data 15 can be (Q_{I},I), which refers to an original value Q of a quantizer at the location I (Iε[0 . . . 63]) of the quantization table. A control object CON containing only the quantizer at the lower location I (scaler of low frequency coefficients) produces more degradation than those having the quantizer at higher location I (corresponding to high frequency coefficients).

By scrambling coefficients of the quantization table, the present invention distinguishes from scrambling packets of JPEG2000 standard, because such packets never contain parameters of the coding format (such as coefficients of the quantization table). Indeed, according to JPEG2000 standard, parameters of the coding format take place in other data structures known as marker segments. Accordingly, the scrambling of packets of JPEG2000 standard does not allow the scrambling of parameters of the coding format of the image.

According to another embodiment, the coefficients stored in the control object can refer both to coding elements of the image (namely DC and/or AC coefficients) and to parameters of the coding format such as coefficients of the quantization matrix. Accordingly, the coefficients used for scrambling/descrambling images by substitution in the present invention can refer to coding elements and/or to parameters of the coding format.

At the end of the scrambling operation of the present invention, the scrambled image 20 (which still refers to an encoded or compressed image) has a coding format having the same syntax as that of the original image. Preferably, the coding format of the scrambled image 20 also preserves the semantics of the coding format of the original image, thanks to including realistic dummy coefficients.

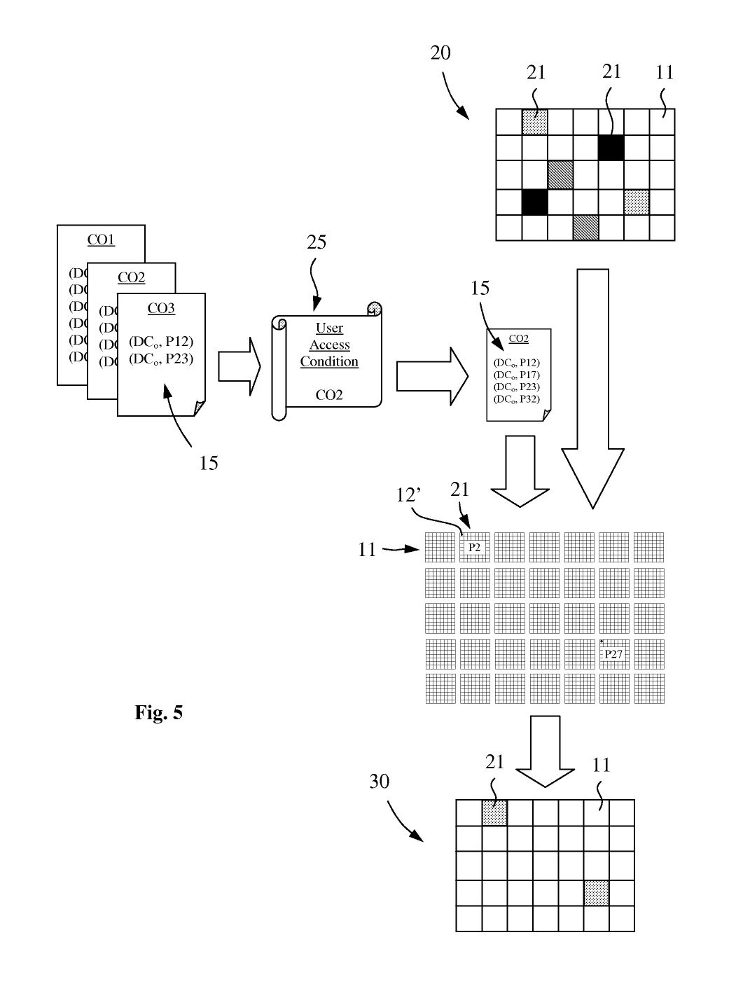

The descrambling operation, which is made as a pseudo-reverse operation after the above scrambling operation, is now described with reference to FIG. 5. The first step of the descrambling operation is to receive, on the one hand, the scrambled image 20 and, on the other hand, at least a part of the control objects CO1, CO2, CO3 generated during the scrambling operation. Receiving the scrambled image and at least one of the control objects can be achieved either by the same channel (for instance by sending both the scrambled image and the control objects) or by two different channels (data streams).

The second step refers to the using of original data 15, deriving from (i.e. coming from or resulting from) a selection of at least one of the control objects generated during the scrambling operation, for obtaining the reconstructed image 30 by putting back the original coefficients 12, 13, instead of said dummy coefficients, thanks to their respective position.

Advantageously, the position of any coefficient, as stored in a 2-tuple, enables to identify the original coefficient (since data included in each 2-tuple form a pair of unique data) and the dummy coefficient without requiring the reading of any coefficient. As this identification is immediate, the related process of substitution is very fast and fully reliable.

According to one embodiment, original data 15 used for obtaining the reconstructed image 30 during the descrambling operation is derived from a selection (of at least one of the control objects) performed during the scrambling operation. Therefore, all the control objects received at the descrambling operation are issued from this selection. Such a selection can be achieved e.g. by a selecting unit located within the system hosting the scrambler or within another entity connected to this system.

According to another embodiment, this selection is performed during the descrambling operation (by an additional step), after having received all the control objects generated during the scrambling operation. As this selection is performed on the basis of the user access condition assigned to each user (or group of users), the scrambler (or the system hosting the scrambler or connected to the later) does not need to manage the access conditions of the users. Thus, the selection can be performed at the user side, during the descrambling operation which can be achieved in a secured environment.

The user access condition can be regarded as a parameter that is specific for a certain user. It defines the remaining degradation level of the reconstructed image, i.e. the quality of the descrambled image after the descrambling operation. Thus, the user access condition can be regarded as data or information used for pointing or for designating one or several specific control objects. However, the user access condition should not be considered as being a decryption key, but should be regarded, for instance, as being a value which is representative of an access level used during the descrambling operation for defining the degradation level of the reconstructed image. Depending on the embodiment, the user access condition can be provided to the descrambling operation as a specific input each time the user wants to access to a scrambled image. However, the user access condition can be also stored in a memory of the device which performs the descrambling operation. Preferably, the user access condition has to be renewed periodically. According to another embodiment, the user access condition can be included within an entitlement control message that must be received periodically by the device processing the descrambling operation.

As shown as example in FIG. 5, the user access condition 25 refers to the control object CO2, namely to original data 15 corresponding to positions P12, P17, P23 and P32 of the image 10, 20. According to the embodiment illustrated in this figure, the control object CO2 (comprising the original data 15) allows to restore original DC coefficients 12 located at these four positions. Consequently, the dummy coefficients 12′ located at positions P2 and P27 cannot be removed given that original data of these two coefficients are not comprised in the control object CO2, but are comprised in the control object CO3 which is not designated by the user access condition 25. As a result, the reconstructed image 30 still comprises two lured blocks of coefficients, as shown in FIG. 5. Therefore, the descrambling image 30 is not the same quality as the original image 10.

As better shown in FIG. 6, control objects CO1, CO2, CO3 are organized in a hierarchical manner where, according to a first embodiment, the control object CO1 comprises the entire original data 15 for reconstructing the image and corresponds therefore to the lowest level of degradation, more particularly to perfect/complete reconstruction (image 30d of FIG. 3). The control objects CO2 and CO3 correspond to higher level of degradation since they are formed by a subset of the original data 15 present in a control object CO1 corresponding to a lower level of degradation. The level of degradation corresponding to control objects CO2 and CO3 is illustrated in FIG. 3 by the images 30c and 30b, respectively. In any case, it should be noted that all of these control objects are different from each other.

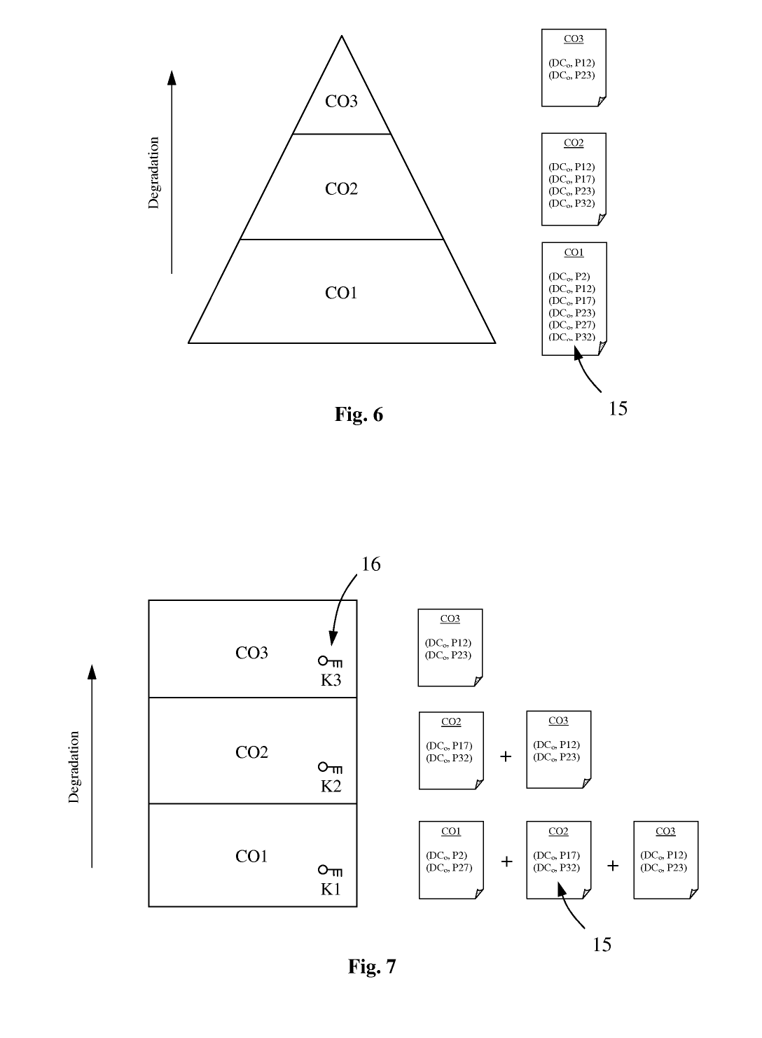

Alternatively, FIG. 7 shows another embodiment of a hierarchical organization of the control objects where each control object CO1, CO2, CO3 is once again different from the others, but preferably comprises non-overlapped original data 15. Each control object therefore comprises at least partly different original data with respect to data of the other control objects. In other words, each control object comprises at least one original data (i.e. at least one 2-tuple) which is different from original data contained in the other control objects. According to a preferred embodiment, data comprised in any control object are unique and are not included in other control objects. Preferably, the selection of one of the control objects (according to the user access condition 25) automatically includes the selection of all the control objects corresponding to a higher level of degradation. This means, according to the illustration of FIG. 7, that the selection of the control object denoted by CO1 automatically includes the selection of all dependent control objects, namely CO2 and CO3. Thus, the designation of the control object CO1 implies the selection of the original DC coefficients 12 located at positions P2, P27, P17, P32, P12, P23, allowing to get the best reconstructed image 30d as shown in the example of FIG. 3. Similarly, the selection of the control object CO2 automatically includes the selection of the control object corresponding to a higher level of degradation, namely the selection of the dependent control object CO3. Therefore, the selection of control object CO2 implies the selection of original values of DC coefficients 12 located at positions P17, P32, P12, P23, allowing to get a reconstruction image 30c provided with a low degradation level as shown in FIG. 3. Given that only three control objects are provided in this example, therefore the selection of the control object CO3 only implies the selection of the original DC coefficients included within this third control object, namely the original values of DC coefficients located at position P12 and P23. Accordingly, the descrambled image corresponds to the reconstructed image 30b of FIG. 3. The last image 30a of FIG. 3 corresponds to the scrambled image 20 since, in this case, no control object would be allowed to the user, for instance due to a denied access. In this case, the user access condition 25 can be empty or it can comprise a default value (or any other default information) corresponding to a denied access.

Advantageously, selecting at the user side (i.e. during the descrambling operation) at least one control object among a plurality of control objects storing original data allows to provide several degradation levels on the basis of same data received by the user, namely the same scrambled images and the same control objects that can be sent to all users (e.g. through a broadcast channel) whatever their access conditions. Accordingly, the upgrading or the downgrading of the access condition assigned to a user does not imply sending to this user other data in addition or instead of those he has already received.

According to a preferred embodiment, the degradation level of the reconstructed image corresponds to the number of blocks, which DC and/or AC coefficients are recovered to their original values thanks to the original data 15.

According to another embodiment, the degradation level of the reconstructed image is inversely proportional to the level of image-details (carried by the transformed coefficient at high frequency), which are correctly inverse-quantized. The more quantizers at the higher frequency are recovered, the lower degradation the reconstructed image suffers from.

According to another embodiment, each control object can be secured against reading by means of an additional encryption step using a key 16, during the scrambling operation. Consequently, the descrambling operation also comprises an additional step for decrypting each encrypted control object by means of this key 16. A single key 16 (or a single pair of public/private keys) could be used for encrypting and/or decrypting all the control objects whatever their organization (i.e. according to FIG. 6 or FIG. 7). In one embodiment, this key (or pair of keys) is unique for each control object and is identified by a key identifier K (e.g. K1, K2, K3) which corresponds to the unique identifier ID of the control object (e.g. CO1, CO2, CO3 respectively) encrypted with this key 16, as shown for instance in FIG. 7, while being also applicable to the embodiment shown in FIG. 6.

In another embodiment, particularly applicable to the hierarchic organization of the control objects shown in FIG. 7, the keys 16 identified by K1, K2, K3 are also organized in a hierarchic manner according to the level of degradation relating to the control objects, so that the access to one of these keys gives access to the keys corresponding to a control object of higher level of degradation. As example with reference to FIG. 7, the access to the Key identified by K1 gives access to the dependent keys identified by K2 and K3 which are required for decrypting the control objects CO2 and CO3 respectively. Similarly, the access to the key identified by K2 gives access to the dependent key identified by K3, but does not provide access to the key identified by K1 for decrypting the control object CO1 which provides a lower level of degradation. Accordingly, the access to the key K3 does not give access to the key K2 or K1.

In a further embodiment, the key 16 of a certain level of degradation is obtained by a hash function of the key related to the lower level of degradation. Advantageously, there is no need to provide more than one key (K1, K2, K3) to a user in order to give him access to the respective control object(s).

In another embodiment, the encryption and decryption steps of the scrambling and descrambling operations can be performed with a key 16 according to a symmetric encryption scheme, or with a paired key 16 according to an asymmetric encryption scheme involving one public key and one private key.

Reference is now made to FIG. 8, which shows the same control objects CO1, CO2, CO3 as above, but with additional original data coming from a calculation of compensated coefficients. Because the DC coefficients of the successive blocks are encoded differentially, the substitution of the value of an original DC coefficient by another value (i.e. by a dummy DC coefficient 12′) causes automatically modifications of the values of the following DC coefficients due to their dependency (correlation), until the end of the image or the next Restart Marker. In particular, the substitution of one DC coefficient 12 influences all downstream DC coefficients, namely the DC coefficients which follow the substituted DC coefficient within the image. This downstream drift effect is specific to the DC coefficients because it depends on their method of calculation which, in this case (due to the differential coding), makes each DC coefficient dependent on the first previous DC coefficient only. By taking into consideration other kinds of coefficients, such as AC coefficients or quantization coefficients/parameters, this drift effect no longer exists because these coefficients/parameters are different and in particular are not based on the above-mentioned differential coding.

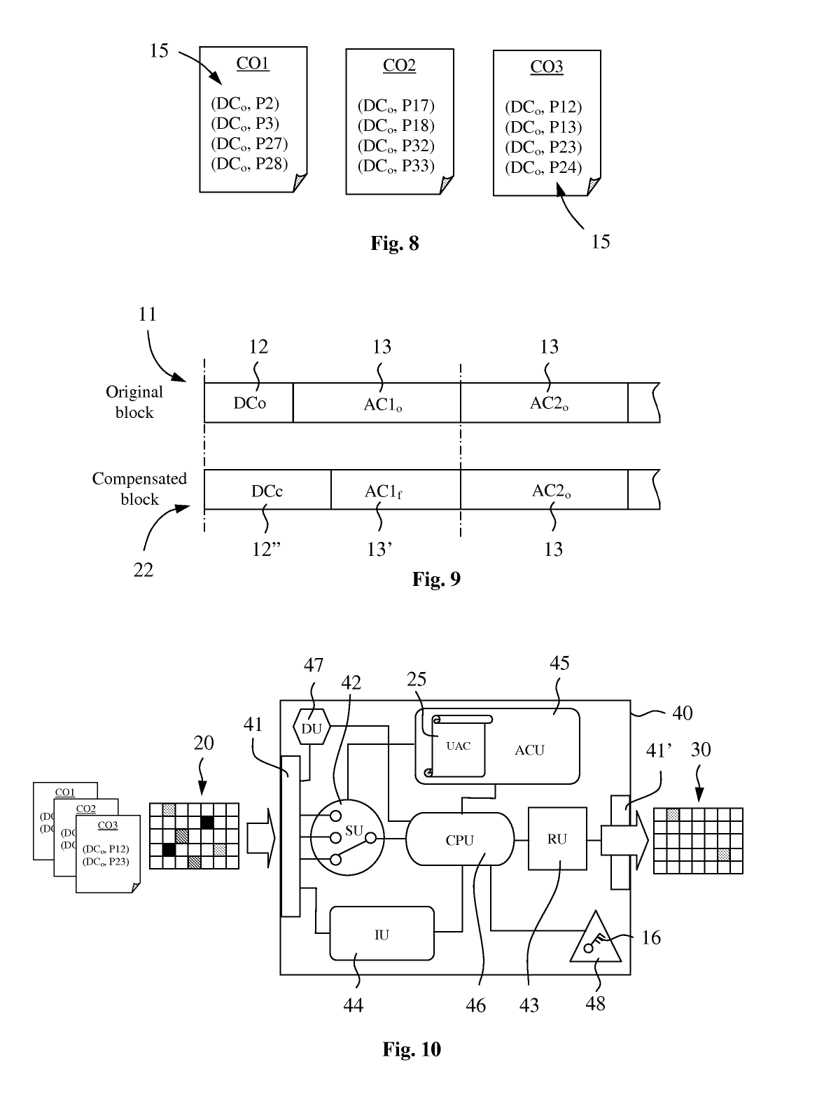

In order to limit the spread of the image degradation caused by this drift effect (cascading effect), especially when the dummy effect is applied to a portion of the image and not its entirety, the method of the present invention suggests that the scrambling operation further comprises, for each block where the drift effect has to be stopped, a step for calculating a compensated coefficient 12″ (FIG. 9) for a so-called compensated block 22 which is one of the following downstream blocks. In particular, the compensated block 22 can be defined as being the block 11 that follows that where the original DC coefficient 12 has been substituted, to avoid any drift effect on the original DC coefficients 12 of the following blocks 11 due to their dependence. In the case where there is a zone consisting a plurality of blocks, the calculation of the compensated coefficient 12″ must be performed for the blocks immediately following the last blocks in each rows of the zone. According to the present invention, the compensated coefficient 12″ is still compatible or compliant with the coding format of the image. More preferably, this compensated coefficient 12″ is part of likely data of this coding format in order to keep the semantics of this coding format.

As shown in FIG. 8, each control object CO1, CO2, CO3 comprises compensated data by comparison to control objects of FIG. 7. Taking the first control object CO1 of FIG. 8 as a first example, original data (DCo) located at positions P2 and P27 have been each provided with compensated data (compensated coefficients), namely the original DC coefficients 12 located at positions P3 and P28; these positions being respectively located after the DC coefficients P2 and P27. Similarly, the control object CO2 of FIG. 8 comprises original DC coefficients located at positions P18 and P33 due to calculation of compensated coefficients 12″ replacing the original DC coefficients at these positions. The same applies for the third control object CO3.

Once the calculation of a compensated coefficient has been made, the scrambling operation of the method also comprises steps aiming to substitute the original DC coefficient 12 of the compensated block 22 by the compensated coefficient 12″, and to store this original DC coefficient 12, together with its position (within the original image or within the bitstream), as additional original data 15 into a control object.

According to one embodiment, the compensated coefficient 12″ is calculated on the basis of the difference between the corresponding dummy coefficient 12′ (i.e. its dummy value) and the corresponding substituted original DC coefficient 12 (i.e. its original value). In particular, this difference is subtracted to the original value of the original DC coefficient 12 which has been substituted by the compensated coefficient 12″.

Referring now for instance to FIG. 9, this figure shows on the one hand a portion of an original block 11 of coefficients, and on the other hand the corresponding portion of the same block including a compensated coefficient 12″ in accordance to variable length coding. The variable length coding (VLC) is a statistical coding technique that assigns code words to the values to be encoded. Short code words are assigned to the values of high occurrence (i.e. to the values which appear frequently in the image), and long code words to those of poor occurrence. On average, short code words are more frequent, so that the encoded string is advantageously shorter than the original data 15. In order to recover the values on the basis of the code words according to a reverse process, a conversion table is established for providing the appropriate initial value that corresponds to each code word. Such a table is usually known by the person skilled in the art under the name of Huffman table.

Although shown here in reference to compensated coefficient, it should be noted that the variable length coding (VLC) is not only applicable to compensated coefficients of compensated blocks 22, but it is also applicable to dummy coefficients of uncompensated blocks (i.e. to dummy coefficients of a scrambled blocks 21).

According to an embodiment of the present invention, the DC coefficients are coded according to a Variable Length Coding and the substitution step (within the scrambling operation) selects the length of the dummy coefficient 12′ as the same as the length of the substituted coefficient 12.

The VLC coding is defined as being of variable length to keep the coding format so that blocks are still fully readable by common players (e.g. to be compliant with the JPEG norm). Regarding to the calculation of compensated coefficients 12″, a first option is to provide a compensated coefficient 12″ (also noted DCc) having the same length (i.e. the same bits length) as the original DC coefficient 12 (also noted DCo). By substituting the original DC coefficient DCo by a compensated coefficient DCc there is no incidence in the following AC coefficients in case where the compensated coefficient DCc is the same length as the original DC coefficient DCo.

However, in case where the length of the compensated coefficient DCc is different (i.e. either shorter or longer) than the original DC coefficients DCo, this bits length difference impacts on the structure of the block by causing a shifting of the AC coefficients. To obviate this shifting, FIG. 9 shows another option focused on VLC coding. In this figure, the first coefficient of the original block 11 is an original DC coefficient 12 (DCo) which is followed by a plurality of original AC coefficients 13 (noted AC1o, AC2o, etc. . . . ). To avoid any shifting in the bitstream, the original AC coefficient AC1o located next to the DC coefficient DCo is substituted by a dummy or a fake AC coefficient 13′ (also noted AC1f). This fake AC coefficient 13′ is chosen so that the sum of the length of the original DC coefficient DCo and the original AC coefficient AC1o is the same as the sum of the length of the compensated coefficient DCc and the fake AC coefficient AC1f taking into account that the fake AC coefficient AC1f is compatible or compliant with the coding format of the image and that this fake coefficient is preferably part of likely data of this coding format in order to keep its semantics. By this means the drift effect resulting from the dummy DC coefficient 12′ is stopped by the compensated coefficient 12″. The fake AC coefficient 13′ used to compensate the shift will add some visual effect which will be limited to their block only, preventing any additional drift effect. Thus, the compensated block 22 may still appear scrambled, but the next block will be decoded correctly.

If the data available through the first AC coefficient AC1o is not enough to fully compensate the drift, then some or all of the AC coefficients from the block can be used to generate the appropriate compensation.

For implementing this way of doing into the method of the present invention, the following features have to be considered. The DC coefficients are coded according to a Variable Length Coding. In case that the length of the compensated coefficient 12″ is different than the length of the original DC coefficient 12, the method comprises the steps of:
extracting at least one AC coefficient 13 following the original DC coefficient 12 (to be compensate),
determining at least one fake AC coefficient 13′ so that the sum of the lengths of the original DC coefficient 12 and the original AC coefficient(s) 13 is the same as the sum of the lengths of the compensated DC coefficient 12″ and the fake AC coefficient(s) 13′, while taking into account that the fake AC coefficient(s) 13′ is (are) compatible with the coding format of the image and more preferably that it respects the semantics of this coding format.

If the quantity of bits available through the first AC coefficient is not sufficient, then some or all the following AC coefficients can be used to generate the compensated DC coefficient 12″ and the fake AC coefficient(s) 13′.

Although FIG. 9 refers to a compensated block 22, the same could be applied to scrambled blocks 21 comprising dummy coefficients 12′ (instead of compensated coefficients 12″), in the case where the length of the dummy coefficients 12′ would be different (i.e. either shorter or longer) than the original DC coefficients 12 (DCo).

According to more general considerations of the invention, the dummy coefficients 12′, 13′ and/or the compensated coefficients 12″ are preferably syntactically and semantically compliant with the coding format of the original image 10. Besides, each of the blocks of coefficients of the image 10 can be identified by a unique identifier. This identifier can be used for identifying the original coefficient of each block. Preferably, each original coefficient is identified by means of its position within the image, e.g. by means of the pair of original data 15 which comprises the value of the original coefficient together with its position within the image. More preferably, the position of each coefficient is referenced with respect to the bitstream, namely by means of a value corresponding to the absolute position of the coefficient within the bitstream. Accordingly, this position enable the system to immediately identify the appropriate coefficient, regardless the nature of data included in the bistream. Still preferably, the determination of the original coefficients that have to be substituted by dummy coefficients is made randomly among all the coefficients of the original image.

The area, within the image, where dummy coefficients are generated can be limited to a portion of the digital image or can be extended to the entire image. According to an embodiment, each control object is defined by an integer value which does not exceed the total number of control objects. The number of original data 15 is preferably equal in each control object referring to embodiments shown in FIGS. 7 and 8. According to another embodiment shown in FIG. 6, the number of original data comprised in each control object is preferably distributed proportionally (for instance, □ of data in CO3, □ of data in CO2 and the entire of data in CO1). Preferably, the user access condition comprises the unique identifier ID of one control object to determine the control object(s) allowed for this user in view of the descrambling operation. The user access condition can also comprise more than one control object identifier ID for designating several control objects. Alternately, the user access condition may comprise a value that determines the number of control objects allowed for said user. Moreover, it should be noted that the number of blocks 11, 21 comprised in a digital image or the number of AC coefficients 13 per block, as shown in the attached figures, is not a restrictive choice but results from an arbitrary choice. Similarly, the number of dummy coefficients is in no way limited to the number shown in the figures and the use of fake (i.e. dummy) coefficients of an image are not limited to replace DC coefficients only, but can also replace AC coefficients, or even both DC and AC coefficients.

According to the present invention, it should be noted that the scrambled image 20 is a fully scrambled image, namely an image which requires the access to all the control objects in order to recover the corresponding original image 10. Accordingly, the scrambled image 20 does not refer to an image which can be assigned to several levels of degradation. Only the reconstructed image 30 refers to a scalable image, since it can refer to a fully descrambled image or to a more or less scrambled image. Besides, it should be also noted that all the images, namely the original image 10, the scrambled image 20 and the reconstructed image 30, have the same nature in order to preserve the coding format (which is defined by the original image). More preferably, no only the syntax of the coding format is safeguarded in the nature of the images 20, 30, but also the semantics so that all the coefficients used for defining these images are likely coefficients (i.e. plausible coefficients) pertaining to this coding format. Therefore, the result of the scrambling is only visually noticeable. Advantageously, this means that any electronic device is fully unable to recognize a scrambled image from an unscrambled image, given that all of them have been defined by coefficients which are fully compliant to the coding format of the original image. Depending on the scrambling level, the visual effect of the scrambled image can even create an artistic visual effect.

The present invention also refers to a system for scrambling an original image, having a certain coding format, into a scrambled image having the same coding format. In accordance with this coding format, the original image 10 is defined by a set of original coefficients, in particular a set of orderly coefficients (i.e. coefficients arranged according to a definite order or a definite pattern such as a matrix or a table, so that they are identifiable by their position within this arrangement or within this pattern). Preferably, these original coefficients refer to coding elements (such as DC/AC coefficients positioned in blocks 11) within this image, and/or to parameters (such as quantization elements) of said coding format within a conversion table (typically a quantization table in which said quantization elements are stored).

Such a system comprises a scrambler for scrambling an original image 10 in a scrambled image 20. The scrambling operation is obtained by substituting a plurality of original coefficients (e.g. AC and/or DC coefficients or elements of a quantization matrix, which can be regarded as being syntax elements) by dummy coefficients (i.e. replacement syntax elements) of the same nature to preserve the coding format. The scrambler is able to generate at least two control objects CO1, CO2, each control object corresponding to a specific degradation level of the original image 10. Besides, each control object comprises, as original data 15, the substituted original coefficients with their respective position. Depending on the kind of coefficients, this position can refer to the position of the coefficients DC/AC within the image or to the position of coefficient (e.g. a quantizer) within a conversion table (e.g. a quantization table). According to a preferred embodiment, this position refers to the absolute position of the coefficient within the bitstream corresponding to the image(s).

Given that each control object corresponds to a different degradation level of the original image 10, a specific user access condition 25 can be assigned to each control object. In one embodiment, the scrambler further comprises a selecting unit for selecting which control object(s) must be available for a specific user on the basis of the user access condition assigned to this user. Further to this selection, the user will be provided with the appropriate control object(s) allowing to descramble the scrambled image 20 in accordance to a degradation level corresponding to his own user access condition. The selecting unit may be also located within another entity connectable to the descrambling device of the user and in charge of managing the user access conditions of all users (or group of users).

According to another embodiment, the scrambler does not proceed with such a selection (and thus does not require a selecting unit) given that it provides, to any user, the scrambled image and all the control objects. Accordingly, the scrambler does not need to manage the user access conditions of the users because the selection is therefore performed at the user side, during the descrambling operation which can be achieved in a secured environment.

Depending on the method implemented in this system and in the case where original coefficients refer to DC/AC coefficients, each dummy coefficients can be also followed by a compensated coefficient which replaces an original coefficient whose value and position are also stored as additional original data 15 in one of the control objects CO1, CO2.

In order to proceed with a pseudo-reverse operation, the present invention also refers to a system 40 for descrambling a scrambled digital image 20, having (or compliant with) a certain coding format, into a scalable reconstructed image 30, having the same coding format. Each image 20, 30 being defined by a set of orderly coefficients 12, 12′, 13, 13′ which preferably refer to coding elements within this image and/or to parameters of said coding format within a conversion table. One embodiment of this system 40 is schematically shown in FIG. 10. The scrambled image 20 comprises a plurality of blocks 21, whose some of them (or at least one of them) have been scrambled by the substitution of their original coefficients 12 by dummy coefficients, as shown in FIG. 2. The scrambled image 20 is associated with at least two control objects CO1, CO2, each corresponding to a specific reconstruction/degradation level of the scrambled image 20. Each control object comprises original data 15 formed by substituted original coefficients 12, 13 and their respective positions. As already explained, this position can refer to a position within a bitstream, within the image or within another matrix such as a quantization table.

The control objects are used for substituting fake coefficients of the scrambled image 20. Fake coefficients can refer to dummy coefficients 12′ and/or compensated coefficient 12″ previously used for replacing original DC coefficients 12, and/or can refer to dummy coefficients 13′ used for replacing original AC coefficients 13. Alternately or in addition, these control objects can comprise other original coefficients such as parameters (e.g. quantizers) of the coding format and their respective positions (within the bitstream or with respect to a matrix such as a conversion table or a quantization table).

The system 40 comprises an input interface 41 for receiving the scrambled image 20 and original data 15 extracted from an original image 10 from which the scrambled image 20 was generated.

This system 40 also comprises a descrambler for generating the reconstructed image 30 by processing at least one control object, among at least two control objects into which original data 15 has been stored in a form of 2-tuples. Each 2-tuple comprises an original coefficient 12, 13 and its position. The processing of control objects is used for substituting dummy data of the scrambled image 20 by the original coefficients 12, 13 thanks to their respective position.

The scrambled image 20 can be received by the input interface 41 as first input and the control objects as second input. Preferably, the control objects are received by a security unit located within the system 40.

According to one embodiment, the system 40 can also comprise a selection unit 42 (SU) to select at least one of the control objects CO1, CO2, CO3 when all the control objects generated by the scrambler are received by the descrambler. The selection is performed in accordance with a user access condition 25.

The descrambler can comprises a replacement unit 43 (RU) to substitute the fake coefficients (dummy DC coefficients 12′, compensated DC coefficients 12″, fake AC coefficients 13′ or fake coefficients of the quantization table) of the scrambled image 20 by the original coefficients (previously substituted during the scrambling operation) extracted from the selected control object(s). The selection unit 42 and/or the extraction and/or the replacement of the control objects can be preferably performed within the security unit.

The reconstructed image 30 can be finally delivered out of this system through an output interface 41′ as shown in FIG. 10.

According to one embodiment, the system 40 further comprises an identification unit 44 (IU) to identify a user wanting to access to the scrambled image 20, and an access condition unit 45 (ACU) for determining the user access conditions 25 (UAC). The user access condition 25 can be imported into the system 40 as third input through the input interface 41.

As shown in FIG. 10, a central processing unit 46 can be used to manage all the components of the system 40 and to ensure the processing of descrambling operation of the method disclosed in the present invention.

Optionally, this system may further comprise a decryption unit 47 (DU) for decrypting control objects CO1, CO2, CO3 with an appropriate key 16 in case where these control objects have been previously encrypted (in one of the manners already disclosed in the present description). To this end, the system can also comprise a security module 48 for storing the appropriate key 16 within a secured environment or for receiving this key as another input under an encrypted message and for processing this message to extract the required key 16. Preferably, the security module 48 and the security unit form the same entity.

Although three control object CO1, CO2, CO3 have been used in the examples of the present detailed description, it should be understood that the present invention is not limited to three control objects. From a general point of view, at least two control objects are defined.

1. A method for scrambling an original digital image into a scrambled image and for descrambling the scrambled image into a reconstructed image, said original image being defined, according to a coding format, by a set of orderly original coefficients which refer to coding elements arranged in blocks with in this image and/or to parameters of said coding format within a conversion table, the method comprising a scrambling operation and a descrambling operation;
the scrambling operation comprising the steps of:
substituting a plurality of said original coefficients by dummy coefficients of the same nature so as to safeguard said coding format; and
storing the substituted original coefficients with their respective position, as original data into at least two control objects, each control object corresponding to a specific degradation level of the original image;
the descrambling operation comprising the steps of:
receiving the scrambled image and at least a part of said control objects; and
using original data derived from a selection of at least one of said control objects, performed on the basis of a user access condition, for obtaining the reconstructed image by putting back the original coefficients instead of said dummy coefficients, by means of their respective position.

2. The method of claim 1, wherein the control object/objects received during the descrambling operation derive from said selection.

3. The method of claim 1, wherein said selection is performed during the descrambling operation, after having received all the control objects generated during the scrambling operation.

4. The method of claim 1, wherein original data stored in the control object corresponding to the higher level of degradation is formed by a subset of the original data stored in a control object corresponding to a lower level of degradation.

5. The method of claim 1, wherein each control object comprises at least partly different original data, the selection of the control object according to the user access condition involves the selection of the control object/objects corresponding to a higher level of degradation.

6. The method of claim 1, wherein each control object is encrypted during the scrambling operation with a key and wherein the descrambling operation comprises an additional step for decrypting said control object.

7. The method of claim 6, wherein said key is unique for each control object and is identified by a key identifier which corresponds to the unique identifier ID of the control object encrypted with this key.

8. The method of claim 7, wherein the keys are organized in a hierarchical manner according to the level of degradation, so that the access to one of said keys gives access to the keys corresponding to a control object of higher level of degradation.

9. Method of claim 8, wherein the key of a level of degradation is obtained by a hash function of the key related to the lower level of degradation.

10. The method of claim 1, wherein said coding format is JPEG compression format and said coefficients refer to DC and/or AC coefficients or to coefficients of a quantization table.

11. The method of claim 10, wherein the scrambling operation further comprises the steps of:
calculating, at each time an original DC coefficient has been substituted, a compensated DC coefficient for a compensated block defined as being the block that follows that where the original DC coefficient has been substituted, to avoid any drift effect on the original DC coefficients of the following blocks due to their dependence;
substituting the original DC coefficient of the compensated block, by said compensated DC coefficient; and
storing the original DC coefficient of the compensated block, together with its position within the original image, as additional original data into one of said control objects.

12. The method of claim 11, wherein said compensated coefficient is calculated on the basis of the difference between the dummy value of the dummy coefficient and the corresponding original value of the substituted original DC coefficient.

13. The method of claim 11, wherein the original DC coefficients are coded according to a Variable Length Coding, the substituting step selects the length of the dummy coefficient as the same as the length of the substituted original coefficient.

14. The method of claim 11, wherein the original DC coefficients are coded according to a Variable Length Coding, in the case where the length of the dummy coefficient or the compensated coefficient is different than the length of the original coefficient, the method comprises the steps of:
extracting at least one original AC coefficient following said original DC coefficient; and
determining at least one fake AC coefficient so that the sum of the lengths of the original DC coefficient and the original AC coefficient is the same as the sum of the lengths of the fake AC coefficient and the dummy coefficient or the compensated coefficient, while taking into account that said fake AC coefficient is compatible with the coding format of the image.

15. The method of claim 11, wherein said dummy coefficients and/or said compensated coefficients are syntactically and semantically compliant with said coding format.

16. A system for scrambling an original digital image into a scrambled image, said original image being defined, according to a coding format, by a set of orderly original coefficients which refer to coding elements positioned in blocks within this image and/or to parameters of said coding format within a conversion table, the system comprising a scrambler which is able, on the one hand, to substitute a plurality of original coefficients by dummy coefficients of the same nature to safeguard said coding format and, on the other hand, to generate at least two control objects, each control object corresponding to a specific degradation level of the original image and each control object comprising, as original data, the substituted original coefficients with their respective position.

17. A system for descrambling a scrambled image, compliant with a coding format, into a scalable reconstructed image having the same coding format, each image being defined by a set of orderly coefficients which refer to coding elements within this image, and/or to parameters of said coding format within a conversion table, the system comprising:
an input interface for receiving the scrambled image and original data extracted from an original image from which the scrambled image was generated;
a descrambler for generating said reconstructed image by processing at least one control object, among at least two control objects wherein said original data has been stored in a form of 2-tuples, each 2-tuple comprising an original coefficient and its position, for substituting dummy data of the scrambled image by the original coefficients thanks to their respective position; and
an output interface for outputting the reconstructed image.

18. The system for descrambling a scrambled image according to claim 17, further comprising:
an identification unit to identify a user accessing the scrambled image and; and
an access condition unit to determine the user access conditions of said identified user.
